(19) United States
(12) Patent Application Publication
(10) Pub. No.: US 2015/0172964 A1
(43) Pub. Date: Jun. 18, 2015

(54) UE CONTEXT RELEASE METHOD, ENB AND HOME ENB GATEWAY

(71) Applicant: ZTE CORPORATION, Shenzhen, Guangdong Province (CN)

(72) Inventors: Ying Huang, Shenzhen (CN); Jin Xi, Shenzhen (CN); Jianjian Zhu, Shenzhen (CN)

(21) Appl. No.: 14/373,296

(22) PCT Filed: Jan. 18, 2013
(86) PCT No.: PCT/CN2013/070690

§ 371 Date: Jul. 18, 2014

(30) Foreign Application Priority Data
Jan. 18, 2012 (CN) 201210015449.6

(51) Int. Cl. H04W 36/00

(52) U.S. Cl. CPC H04W 36/0033; H04W 88/08

(57) ABSTRACT

The present invention provides a UE context release method, eNB and home eNB gateway. The method comprises the following steps: a source eNB determines whether the gateway release determination information sent from the home eNB gateway has been received after a user terminal finishes the handover; and if the source eNB has received the gateway release determination information, the signaling being used to indicate the home eNB gateway to release the context of the user terminal is prohibited from being sent to the home eNB gateway. The present invention solves the problem in the related art that the source eNB sends the redundant signaling being used to indicate the home eNB gateway to release the context of the user terminal after X2 handover procedure, thereby improving the utility efficiency of the signaling indicating the home eNB gateway to release the context of the user terminal, and effectively saving the cost necessary for sending the signaling indicating the home eNB gateway to release the context of the user equipment.

### TECHNICAL FIELD

The disclosure relates to the field of communications, in particular, to a UE context release method of a gateway, an eNB and a home eNB gateway.

### BACKGROUND

A home eNB is called HeNB in an LTE (Long Term Evolution) system. The functions supported by the HeNB are substantially consistent to that supported by the macro eNB (also referred to as eNB for short), and the process between the HeNB and an EPC (Evolved Packet Core) is substantially consistent to that between the eNB and the EPC. Since the deployment of an HeNB generally has not experienced network planning of a mobile operator, the coverage range of an HeNB is small, and the amount of HeNBs is large, in order to manage and support a larger amount of HeNBs more conveniently, under an E-UTRAN (Evolved UMTS Terrestrial Radio Access Network) architecture, it is also possible to introduce a new network element HeNB GW (Home eNB gateway) between the S1 connection of the HeNB and the EPC. In R10, an HeNB can be connected with an MME (Mobility Management Entity) as an S1 proxy via an HeNB GW.

In LTE R10, an X2 direct interface exists between HeNBs, and load balance, handover optimization, information exchange, etc. can be performed via the X2 interface; that is, if an X2 interface exists between a source HeNB and a target HeNB, an X2 handover procedure can be adopted between the HeNBs. When the handover is finished, the source HeNB sends an S1AP UE context release message (S1 UE context release request message), wherein the message carries GW Context Release Indication IE (UE context release indication for a home eNB gateway), so as to indicate the HeNB GW of the source HeNB to release the context of the handover UE. If the source HeNB establishes an S1 interface with the MME via the HeNB GW (Gateway), the S1AP message (S1 UE context release request message) is firstly received by the HeNB GW, the HeNB GW parses the GW context release indication in the message, terminates the S1AP message, and performs corresponding processing (such as releasing the context of the UE (user equipment)); if the HeNB does not establish an S1 interface via the HeNB GW but directly with the MME, the S1AP message is directly sent to the MME by the source HeNB, and the MME parses the GW context release indication in the message, and does not perform any processing. However, if the source HeNB and the target HeNB both establish an S1 interface via the same HeNB GW with the MME, then after the X2 handover procedure, the HeNB GW can learn that handover has happened to the UE through a path switch process, and perform corresponding processing on the UE context, without the need of additionally sending an S1AP message to indicate the HeNB GW to perform corresponding processing; therefore, in the above-mentioned case, the S1AP UE context release request message is a redundant message. With the research of LTE R11, the problem of the redundant message is not solved yet.

### SUMMARY

The disclosure provides a UE context release method, eNB and home eNB gateway, so as to at least solve the problem in the related art that after the X2 handover procedure, the source eNB sends a redundant signaling indicating the home eNB to release the context of the user equipment.

According to an aspect of the disclosure, a UE context release method is provided. The method includes: a source evolved Node B (eNB) determining whether gateway release determination information sent from a home eNB gateway has been received after user equipment finishes handover; if the source eNB has received the gateway release determination information, prohibiting a signaling, which is used to indicate the home eNB gateway to release context of the user equipment, from being sent to the home eNB gateway.

Before the source eNB determines whether the gateway release determination information sent from the home eNB gateway has been received, the source eNB receives the gateway release determination information, wherein a manner of the source eNB receiving the gateway release determination information includes: receiving a UE context release message or a handover request acknowledge message sent from the home eNB gateway to the source eNB, wherein the UE context release message or the handover request acknowledge message carries the gateway release determination information.

If the source eNB establishes a proxy X2 interface with a target eNB via the home eNB gateway, the home eNB gateway sending the UE context release message or the handover request acknowledgment message, carrying the gateway release determination information, to the source eNB includes: the home eNB gateway receiving the UE context release message or the handover request acknowledgment message sent by the target eNB; the home eNB gateway adding the gateway release determination information to the UE context release message or the handover request acknowledgment message, and sending to the source eNB the UE context release message or the handover request acknowledge message, which is added with the gateway release determination information; or if the source eNB establishes a proxy X2 interface with the target eNB via the gateway, the home eNB gateway sending the UE context release message or the handover request acknowledge message, carrying the gateway release determination information, to the source eNB includes: the home eNB gateway forwarding to the source eNB the UE context release message or the handover request acknowledge message which carries the gateway release determination information and is sent by the target eNB.

The gateway release determination information at least includes one indication of the following: proxy connection indication, and indication prohibiting the signaling being used to indicate the home eNB gateway to release the context of the user equipment from being sent to the home eNB gateway.

According to another aspect of the disclosure, an evolved Node B (eNB) is provided. The eNB includes: a determination module, configured to determine whether gateway release determination information sent from a home eNB gateway has been received after user equipment finishes handover; a processing module, configured to prohibit, in a case where the determination module determines that the gateway release determination information sent from the home eNB gateway has been received, a source eNB from sending to the home eNB gateway a signaling being used to indicate the home eNB gateway to release context of the user equipment.

The eNB further includes: a receiving module, configured to receive the gateway release determination information sent by the home eNB gateway, wherein a manner for receiving the gateway release determination information sent by the home eNB gateway includes: receiving a UE context release message or a handover request acknowledge message sent by the home eNB gateway to the source eNB, wherein the UE context release message or the handover request acknowledge message carries the gateway release determination information.

The gateway release determination information at least includes one indication of the following: proxy connection indication, and indication prohibiting the signaling being used to indicate the home eNB gateway to release the context of the user equipment from being sent to the home eNB gateway.

According to still another aspect of the disclosure, a home evolved Node B (eNB) gateway is provided. The home eNB gateway includes: a first sending module, configured to send to a source eNB a UE context release message carrying gateway release determination information; a second sending module, configured to send to the source eNB a handover request acknowledge message carrying the gateway release determination information.

The first sending module includes: a first receiving unit, configured to receive the UE context release message sent by a target eNB; a first sending unit, configured to add the gateway release determination information to the UE context release message when the source eNB establishes a proxy X2 interface with the target eNB via the home eNB gateway, and send to the source eNB the UE context release message which is added with the gateway release determination information; or a second sending unit, configured to forward to the source eNB the UE context release message which carries the gateway release determination information and is sent by the target eNB, when the source eNB establishes a proxy X2 interface with the target eNB via the gateway.

The second sending module includes: a second receiving unit, configured to receive the handover request acknowledge message sent by a target eNB; a third sending unit, configured to add the gateway release determination information to the handover request acknowledge message, when the source eNB establishes a proxy X2 interface with the target eNB via the home eNB gateway, and send to the source eNB the handover request acknowledge message which is added with the gateway release determination information; or a fourth sending unit, configured to forward to the source eNB the handover request acknowledge message which carries the gateway release determination information and is sent by the target eNB, when the source eNB establishes a proxy X2 interface with the target eNB via the gateway.

The gateway release determination information at least includes one indication of the following: proxy connection indication, and indication prohibiting the signaling being used to indicate the home eNB gateway to release the context of the user equipment from being sent to the home eNB gateway.

In the disclosure, after the handover of the user equipment is finished, the source eNB determines whether the gateway release determination information sent by the home eNB gateway is received; the source does not send to the home eNB gateway the signaling indicating the home eNB gateway to release the context of the user equipment when it is determined that the gateway release determination information sent by the above-mentioned home eNB gateway is received; that is, the determination condition that the source eNB does not send the signaling indicating the home eNB gateway to release the context of the user equipment is provided, reducing the redundant transmission of the signaling indicating the home eNB gateway to release the context of the user equipment, and thus improving the utility efficiency of signaling indicating the home eNB gateway to release the context of the user equipment, effectively saving the cost necessary for sending the signaling indicating the home eNB gateway to release the context of the user equipment.

### BRIEF DESCRIPTION OF THE DRAWINGS

Drawings, provided for further understanding of the disclosure and forming a part of the specification, are used to explain the disclosure together with embodiments of the disclosure rather than to limit the disclosure. In the drawings:

FIG. 1 shows a flowchart of a UE context release method according to an embodiment of the disclosure;

FIG. 2 shows a schematic diagram of an E-UTRAN network architecture of a home eNB according to a preferred embodiment of the disclosure;

FIG. 3 shows a schematic diagram of the architecture of a connection mode between a source eNB and target eNB according to a preferred embodiment of the disclosure;

FIG. 4 shows a schematic diagram of the architecture of a connection mode between another source eNB and target eNB according to a preferred embodiment of the disclosure;

FIG. 5 shows a schematic diagram of the architecture of a connection mode between yet another source eNB and target eNB according to a preferred embodiment of the disclosure;

FIG. 6 shows a flowchart of adding gateway release judgment information to a UE context release message by a home eNB gateway according to a preferred embodiment of the disclosure;

FIG. 7 shows a flowchart of adding gateway release judgment information to a UE context release message by a target eNB according to an embodiment of the disclosure;

FIG. 8 shows a flowchart of adding gateway release judgment information to a handover request acknowledge message by a home eNB gateway according to a preferred embodiment of the disclosure;

FIG. 9 shows a flowchart of adding gateway release judgment information to a handover request acknowledge message by a target eNB according to a preferred embodiment of the disclosure;

FIG. 10 shows a flowchart of sending an S1 UE context release request message by a source eNB according to a preferred embodiment of the disclosure;

FIG. 11 shows a flowchart of sending an S1 UE context release request message by a source eNB according to another embodiment of the disclosure;

FIG. 12 shows a block diagram of the structure an eNB according to an embodiment of the disclosure;

FIG. 13 shows a block diagram of the structure an eNB according to a preferred embodiment of the disclosure;

FIG. 14 shows a block diagram of the structure a home eNB gateway according to an embodiment of the disclosure;

FIG. 15 is a block diagram of the structure of a first sending module according to a preferred embodiment of the disclosure;

FIG. 16 is a block diagram of the structure of a second sending module according to a preferred embodiment of the disclosure.

### DETAILED DESCRIPTION OF THE EMBODIMENTS

The disclosure is described below with reference to the accompanying drawings and embodiments in detail. Note that, the embodiments of the disclosure and the features of the embodiments can be combined with each other if there is no conflict.

In each of the following embodiments, communication can be realized via wireless connection or wired communication or a combination of both, which is not limited in the disclosure.

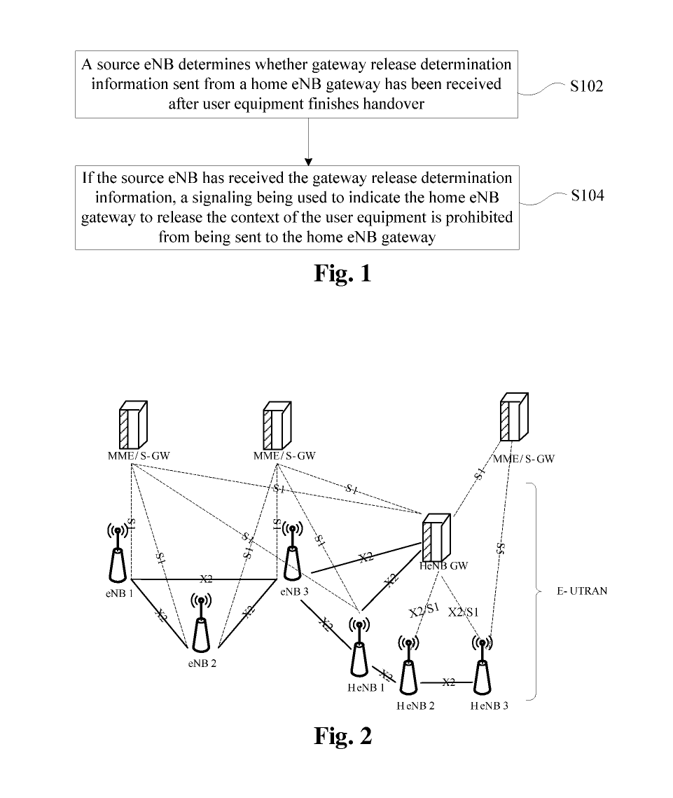

FIG. 1 shows a flowchart of a UE context release method according to an embodiment of the disclosure, as shown in FIG. 1, the UE context release method includes:

S102: a source eNB determines whether gateway release determination information sent from a home eNB gateway has been received after user equipment finishes handover; and

S104: if the source eNB has received the gateway release determination information, a signaling being used to indicate the home eNB gateway to release the context of the user equipment is prohibited from being sent to the home eNB gateway.

In the above-mentioned preferred embodiment, after the handover of the user equipment is finished (for example, after the X2 handover of the user equipment is finished), the source eNB determines whether the gateway release determination information sent by the home eNB gateway is received; the source does not send the signaling indicating the home eNB gateway to release the context of the user equipment to the home eNB gateway when it is determined that the gateway release determination information sent by the above-mentioned home eNB gateway is received (for example, the signaling indicating the home eNB gateway to release the context of the user equipment may be an S1 UE context release request message), reducing the redundant transmission of the signaling indicating the home eNB gateway to release the context of the user equipment, and effectively saving the cost necessary for sending the signaling indicating the home eNB gateway to release the context of the user equipment.

In order to improve the implementation of the disclosure, this preferred embodiment provides a preferred manner of a source eNB receiving gateway release determination information, for example, before the source eNB determines whether the gateway release determination information sent by the home eNB gateway is received, the source eNB can receive the gateway release determination information by receiving the UE context release message or handover request acknowledge message which carries the gateway release determination information and is sent to the source eNB by the home eNB gateway.

In the above-mentioned preferred embodiment, the source eNB receives the gateway release determination information by receiving the UE context release message or the handover request acknowledge message, wherein after the X2 handover of the user equipment is finished, the above-mentioned handover request acknowledge message is an X2 handover request acknowledgement message.

This preferred embodiment provides a method for sending gateway release determination information, if the source eNB establishes a proxy X2 interface with a target eNB via the home eNB gateway, the home eNB gateway sending a UE context release message or a handover request acknowledge message, carrying gateway release determination information, to the source eNB may include: the home eNB gateway receiving the UE context release message or handover request acknowledge message sent by the target eNB; the home eNB gateway adding the gateway release determination information to the UE context release message or the handover request acknowledge message, and sending the UE context release message or the handover request acknowledge message, carrying the gateway release determination information, to the source eNB; or if the source eNB establishes a proxy X2 interface with the target eNB via the gateway, the home eNB gateway sending to the source eNB the UE context release message or the handover request acknowledge message, carrying the gateway release determination information, may include: the home eNB gateway forwarding to the source eNB the UE context release message or the handover request acknowledge message, carrying the gateway release determination information, sent by the target eNB.

In this preferred embodiment, when a source eNB establishes a proxy X2 interface with a target eNB via a home eNB gateway, gateway release determination information will be added to the UE context release message or handover request acknowledge message via the home eNB gateway or the target eNB, so as to satisfy usage requirements in different scenarios, and to finally indicate the source eNB whether it is required to send a signaling indicating the home eNB gateway to release the context of user equipment.

The above-mentioned preferred embodiments are further illustrated hereinafter in conjunction with examples.

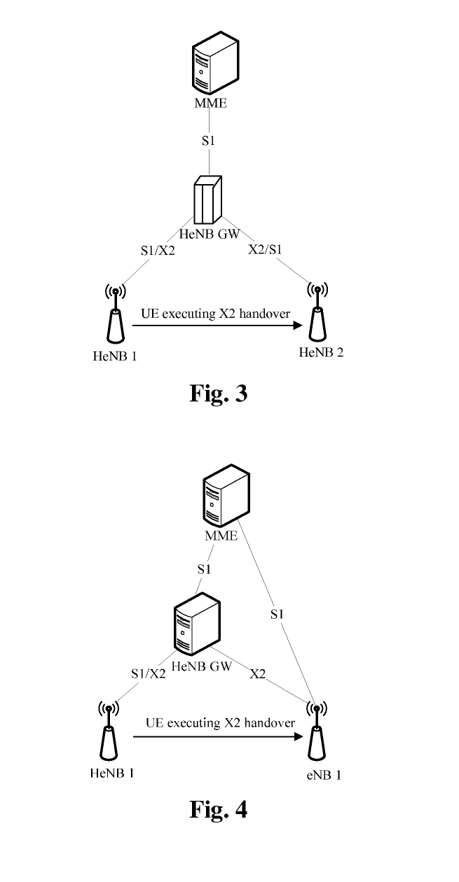

On the basis of each of the above-mentioned preferred embodiment, the source eNB can establish a plurality of connection modes with the target eNB via the home eNB gateway, and the HeNB (home eNB) can be connected with the MME as an S1 proxy via the HeNB GW (home eNB gateway); and if the HeNB is connected with the MME as an S1 proxy via the HeNB GW, the HeNB GW relays the S1 signaling relevant to the UE. In R10, an X2 direct interface exists between HeNBs, and user equipment handover optimization can be performed between the HeNBs via the X2 direct interface, but an X2 interface between the macro eNB and the home eNB is not supported. In R11, the HeNB GW does not only has the function of an S1 proxy, and may also has the function of an X2 proxy; that is, the source eNB and the target eNB establish a proxy X2 interface via the HeNB GW, and a direct X2 interface or a proxy X2 interface might be supported both between an eNB (macro eNB) and a HeNB, and between an HeNB and another HeNB. As shown in FIG. 2, eNB 3 in FIG. 2 may establish a direct X2 interface with HeNB 1, but establish a proxy X2 interface with HeNB 2; HeNB 1 can establish a direct X2 interface with HeNB 2, but establish a proxy X2 interface with HeNB 3; if the source HeNB and the target HeNB (or eNB) are connected via the HeNB GW by means of the X2 proxy, the X2 message is forwarded to an opposite-end eNB by the HeNB GW in the X2 handover procedure, therefore, in this condition, the HeNB GW learns that the handover has occurred to the UE, and there is no need for an additional signaling to indicate the HeNB GW to release the UE context (the context of the user equipment). Particularly, in the following scenarios, it is possible not to send an additional signaling to indicate the HeNB GW to release the UE context. As shown in FIG. 3, the UE executes X2 to handover to HeNB 2 from HeNB 1; a proxy X2 interface is established between HeNB 1 and HeNB 2 via the HeNB GW, and HeNB 1 and HeNB 2 are both connected with the MME via the HeNB GW. As shown in FIG. 4, the UE executes X2 to handover to eNB 1 from HeNB 1 and a proxy X2 interface is established between HeNB 1 and eNB 1 via the HeNB GW; and HeNB 1 is connected with MME via the HeNB GW, and eNB 2 is not connected with the MME via the HeNB GW. As shown in FIG. 5, the UE executes X2 to handover to HeNB 2 from HeNB 1, a proxy X2 interface is established between HeNB 1 and HeNB 2 via the HeNB GW; and HeNB 1 is connected with the MME via the HeNB GW, and eNB 2 is not directly connected with the MME via the HeNB GW. In the above-mentioned scenarios, if according to the existing R10 protocol specification, after the X2 handover is executed, the source HeNB will send a redundant S1 UE context release request message to indicate the HeNB GW to release the UE context; in the disclosure, gateway release determination information is carried in the UE context release message and the handover request acknowledge message to indicate the source eNB not to send the S1 UE context release request message, so as to save the cost necessary for sending the UE context release request message.

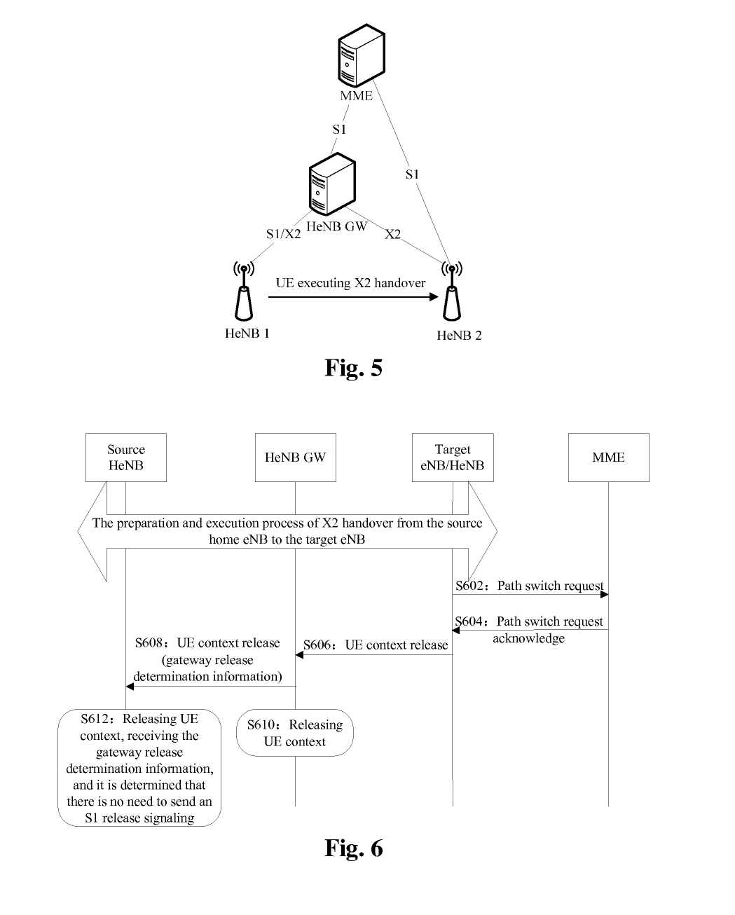

Now examples will be combined to describe the flow of a home eNB gateway adding gateway release determination information to a UE context release message to indicate the source eNB not to send an S1 UE context release message. In this example, the source HeNB establishes an X2 proxy connection with a target eNB via a HeNB GW, if not specifically indicated, if the HeNB is connected with a MME via the HeNB GW herein, the S1 message should be forwarded via the HeNB GW, wherein the target eNB can be a macro eNB and can also be a home eNB; as shown in FIG. 6, the flow of the home eNB adding the gateway release determination information to the UE context release message includes:

S602: after the preparation and execution process of X2 handover from the source HeNB to a target eNB is finished, the target eNB sends a path switch request message to the MME; if the target eNB is a home eNB, the target eNB and the source home eNB are connected with the MME via the same HeNB GW, the message is received by the home eNB gateway and sent to the MME, and the HeNB GW receives the message and performs corresponding processing on the context relevant to the S1 connection for UE handover, which includes updating the S1AP ID mapping relationship table of the UE; the HeNB GW can assign a new S1AP ID for the UE or continue to use the original S1AP ID;

S604: the MME sends a path switch request acknowledge message to the target eNB;

S606: the target eNB sends the UE context release message to the source HeNB, so as to indicate the source HeNB to release the context of UE handover; since the source HeNB establishes an X2 proxy connection via the HeNB GW with the target eNB, the message is routed and forwarded to the source eNB by the HeNB GW;

S608: after the HeNB GW receives the UE context release message, the message is added with the gateway release determination information and sent to the source eNB, wherein the gateway release determination information can be proxy connection indication or indication prohibiting sending to the home eNB gateway a signaling for indicating the home eNB gateway to release the context of the user equipment;

S610: the HeNB GW releases the context of UE handover, for example, S1AP ID, X2AP ID, etc., if corresponding processing is performed on the context relevant to the S1 connection of the UE handover in the path switch process, after the HeNB GW receives the path switch request message, in step S904, then in this step the HeNB GW only needs to release the X2 connection relevant context of the UE handover, such as X1AP ID; otherwise, in this step, the HeNB GW not only needs to release the X2 connection relevant context of the UE handover, such as X2AP ID, but also needs to release the S1 connection relevant context of the UE handover, such as S1AP ID; this step does not have a chronological order relationship with step S612, and may happen before step S612 or after step S612; and

S612: the source HeNB receives the UE context release message, releases the context information of the UE and obtains the gateway release determination information by parsing the message, and it is determined that there is no need to send an S1 release signaling (UE context release request message) to indicate the HeNB GW to release the context of the UE handover.

This embodiment describes the flow of a target eNB adding gateway release determination information to a UE context release message to indicate the source eNB not to send an S1 UE context release message. The source HeNB establishes an X2 proxy connection with a target eNB via a HeNB GW, if not specifically indicated, if the HeNB is connected with a MME via the HeNB GW herein, the S1 message should be forwarded via the HeNB GW, wherein the target eNB is a macro eNB; as shown in FIG. 7, the flow of the home eNB adding the gateway release determination information to the UE context release message includes:

S702: after the preparation and execution process of X2 handover from the source HeNB to the target eNB is finished, the target eNB sends a path switch request message to the MME;

S704: the MME sends a path switch request acknowledge message to the target eNB;

S706: the target eNB determines the type of the X2 connection between the target eNB and the source HeNB, if the source HeNB establishes X2 proxy connection with the target eNB via the HeNB GW, the HeNB GW indicates the target eNB that between the target eNB and the source HeNB is X2 proxy connection in the process of X2 setup or TNL address discovery; or, IEs contained in X2 setup response messages in the cases of proxy connection establishment or direct connection establishment are different, then the target HeNB can determine the type of the connection between the target HeNB and the source eNB according to the IE contained in the content of the X2 setup response message; in this embodiment, if the target eNB determines that between the target eNB and the source HeNB is proxy X2 connection;

S708: the target eNB sends a UE context release message to the source HeNB, so as to indicate the source HeNB to release the context of the UE handover, with the message containing gateway release determination information, wherein the gateway release determination information can be proxy connection indication or indication prohibiting sending to the home eNB gateway a signaling for indicating the home eNB gateway to release the context of the user equipment;

S710: the HeNB GW receives the UE context release message and then routes the message to the source HeNB;

S712: the HeNB GW releases the context of the UE handover, containing A1AP ID, X2AP ID, etc., this step has no chronological order relationship with step S714, that is, it may happen before step S714 or after step S714;

S714: the source HeNB receives the UE context release message, releases the context of the UE handover, and obtains the gateway release determination information by parsing the message, then it is determined that there is no need to send an S1 release signaling (UE context release request message) to indicate the HeNB GW to release the context of the UE handover.

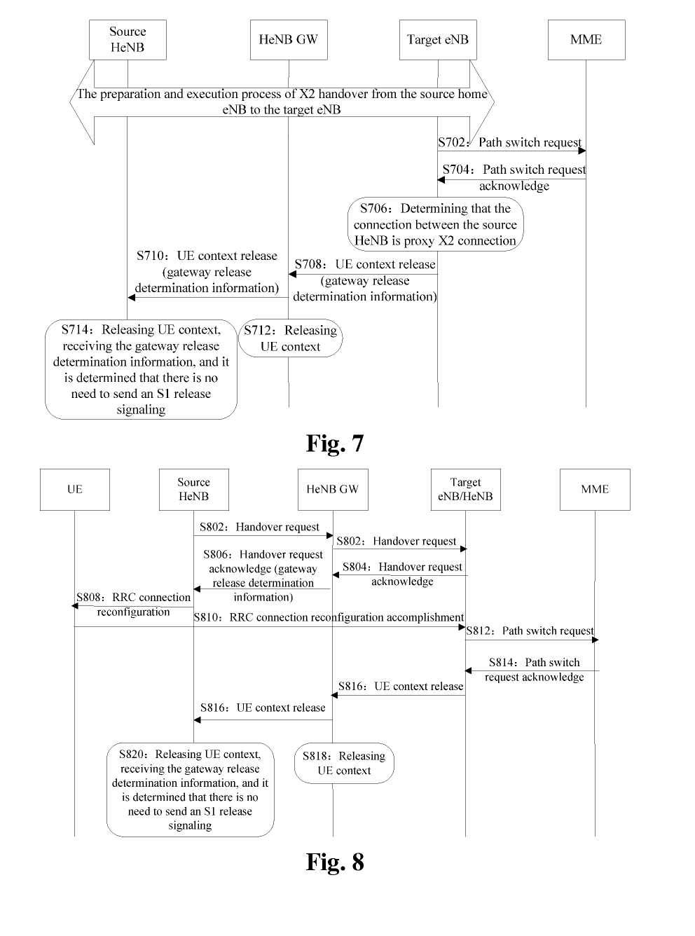

This embodiment describes the flow of a home eNB gateway adding gateway release determination information to a handover request acknowledge (handover request ACK) message to indicate the source eNB not to send an S1 UE context release message. In this example, the source HeNB establishes an X2 proxy connection with a target eNB via a HeNB GW, if not specifically indicated, if the HeNB is connected with a MME via the HeNB GW herein, the S1 message should be forwarded via the HeNB GW, wherein the target eNB can be a macro eNB and can also be a home eNB; as shown in FIG. 8, the flow of the home eNB adding the gateway release determination information to the UE context release message includes:

S802: the source HeNB receives a measurement report sent by the UE, and sends a handover request message to the target eNB, so as to initiate an X2 handover flow; since the X2 proxy connection is established by the source HeNB and the target eNB via the HeNB GW, the message is routed and forwarded to the target eNB by the HeNB GW;

S804: the target eNB accepts the handover request and sends a handover request acknowledge message to the source HeNB, with the message not containing gateway release determination information;

S806: after the HeNB GW receives the handover request acknowledge message sent by the target eNB, the message is added with the gateway release determination information and sent to the source eNB, wherein the gateway release determination information can be proxy connection indication or indication prohibiting sending to the home eNB gateway a signaling indicating the home eNB gateway to release the context of the user equipment;

S808: the source HeNB sends an RRC (Radio Resource Control) connection reconfiguration message to the UE, with the message containing mobile control information, indicating the UE to perform corresponding handover operation, such as uplink synchronous operation with the target eNB;

S810: after finishing the uplink synchronous operation with the target eNB, the UE sends the RRC connection reconfiguration message to the target eNB;

S812: the target eNB sends a path switch request message to the MME, so as to switch the user-plane data plane of the user; if the target eNB is a home eNB, the target eNB and the source home eNB are connected with the MME via the same HeNB GW, then the message is received by the home eNB gateway and sent to the MME, and the HeNB GW receives the message and performs corresponding processing on the context relevant to the S1 connection for the UE handover, which includes updating the S1AP ID mapping relationship table of the UE; the HeNB GW can assign a new S1AP ID for the UE or continue to use the original S1AP ID;

S814: the MME replies a path switch request acknowledge message to the target eNB;

S816: the target eNB sends the UE context release message to the source HeNB, so as to indicate the source HeNB that the UE has finished the switch flow thereof and has released the resource thereof; since the source HeNB establishes an X2 proxy connection with the target eNB via the HeNB GW, the message is routed and forwarded to the source eNB by the HeNB GW;

S818: the HeNB GW releases the relevant resource of the UE handover, for example, S1AP ID, X2AP ID, etc., if corresponding processing is performed on the context relevant to the S1 connection of the UE handover after the HeNB GW receives the path switch request message in step S812, then in this step the HeNB GW only needs to release the X2 connection relevant context of the UE handover, such as X1AP ID; otherwise, in this step, the HeNB GW not only needs to release the X2 connection relevant context of the UE handover, such as X2AP ID, but also needs to release the S1 connection relevant context of the UE handover, such as S1AP ID; this step does not have a chronological order relationship with step S820, and may happen before step S820 or after step S820; and

S820: the source HeNB receives the UE context release message and releases the context of the UE handover, and since the source HeNB obtains the gateway release determination information when receiving the handover request acknowledge message at step S816, and it is determined that there is no need to send an S1 release signaling (UE context release request message) to indicate the HeNB GW to release the context of the UE handover.

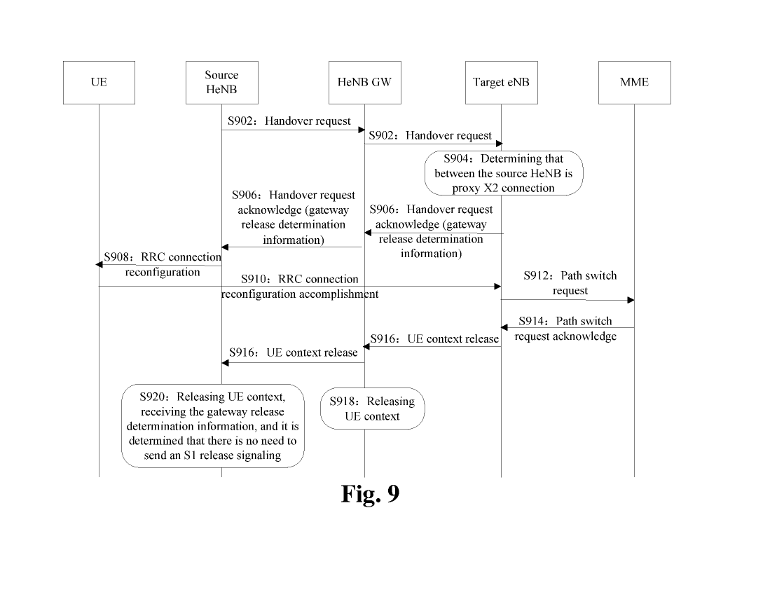

This embodiment describes the flow of a target eNB adding gateway release determination information to a handover request acknowledge (handover request ACK) message to indicate the source eNB not to send an S1 UE context release message. The source HeNB establishes an X2 proxy connection with a target eNB via a HeNB GW, if not specifically indicated, if the HeNB is connected with a MME via the HeNB GW herein, the S1 message should be forwarded via the HeNB GW, wherein the target eNB is a macro eNB; as shown in FIG. 9, the flow of the home eNB adding the gateway release determination information to the UE context release message includes:

S902: the source HeNB receives a measurement report sent by the UE, and sends a handover request message to the target eNB, so as to initiate an X2 handover flow; since the X2 proxy connection is established by the source HeNB and the target eNB via the HeNB GW, the message is routed and forwarded to the target eNB by the HeNB GW;

S904: the target eNB determined the type of the X2 connection between the target eNB and the source HeNB, if the source HeNB establishes X2 proxy connection with the target eNB via the HeNB GW, the HeNB GW indicates the target eNB that between the target eNB and the source HeNB is X2 proxy connection in the process of X2 setup or TNL address discovery; or, IEs contained in X2 setup response messages in the cases of proxy connection establishment or direct connection establishment are different, then the target HeNB can determine the type of the connection between the target HeNB and the source eNB according to the IE contained in the content of the X2 setup response message; in this embodiment, the target eNB determines that between the target eNB and the source HeNB is proxy X2 connection;

S906: the target eNB accepts the handover request and then sends a handover request acknowledge message to the source HeNB, with the message containing gateway release determination information, wherein the gateway release determination information may be an proxy connection indication or an indication prohibiting sending to the home eNB gateway a signaling indicating the home eNB to release the context of the user equipment; since the source HeNB establishes X2 proxy connection with the target eNB via the HeNB GW, and the message is routed and forwarded to the source eNB by the HeNB GW;

S908: the source HeNB sends an RRC connection reconfiguration message to the UE, with the message containing mobile control information, indicating the UE to perform corresponding handover operation, such as uplink synchronous operation with the target eNB;

S910: after finishing the uplink synchronous operation with the target eNB, the UE sends a RRC connection reconfiguration accomplishment message to the target eNB;

S912: the target eNB sends a path switch request message to the MME, so as to switch the user-plane data plane of the user;

S914: the MME replies a path switch request acknowledge message to the target eNB;

S916: the target eNB sends the UE context release message to the source HeNB, so as to indicate the source HeNB that the UE has finished the switch flow thereof and has released the context thereof; since the source HeNB establishes an X2 proxy connection with the target eNB via the HeNB GW, the message is routed and forwarded to the source eNB by the HeNB GW;

S918: the HeNB GW releases the context of the UE handover, containing A1AP ID, X2AP ID, etc., this step has no chronological order relationship with step S920, that is, it may happen before step S920 or after step S920;

S920: the source HeNB receives the UE context release message and releases the context of the UE handover, and since the source HeNB obtains the gateway release determination information when receiving the handover request acknowledge message at step S906, and it is determined that there is no need to send an S1 release signaling (UE context release request message) to indicate the HeNB GW to release the context of the UE handover.

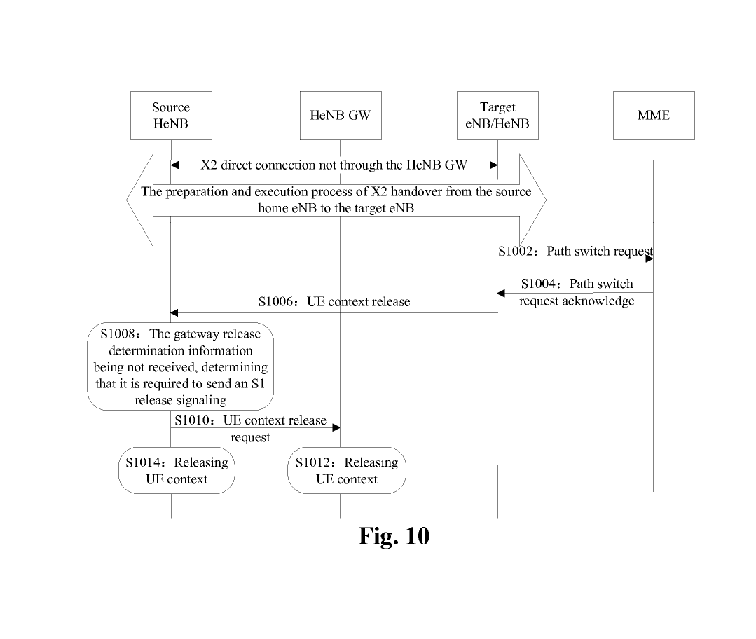

This embodiment describes the flow of a source eNB sending an S1 UE context release request message. In this embodiment, no direct X2 connection is established between the HeNB and the target eNB via the HeNB GW, wherein the target eNB can be a macro eNB and can also be a home eNB; as shown in FIG. 10, the flow of the source eNB sending an S1 UE context release request message includes:

S1002: after the preparation and execution process of X2 handover from the source HeNB to the target eNB is finished, the target eNB sends a path switch request message to the MME;

S1004: the MME sends a path switch request acknowledge message to the target eNB;

S1006: the target eNB sends the UE context release message to the source HeNB, so as to indicate the source HeNB to release the context of the UE handover; since between the HeNB and the target eNB is direct X2 connection, the message is not routed and forwarded by the HeNB GW;

S1008: after the source HeNB receives the UE context release message, the message does not contain the gateway release determination information, and then it is determined that it is required to send an S1 release signaling (UE context release request message) to indicate the HeNB GW to release the context of the UE handover;

S1010: the source HeNB sends an S1AP UE context release request message to indicate the HeNB GW to release the context of the UE handover;

S1012: the HeNB GW releases the context of the UE handover, for example, A1AP ID, this step has no chronological order relationship with step S1014, that is, it may happen before step S1014 or after step S1014;

S1014: the source HeNB releases the context of the UE handover.

This embodiment describes the flow of a source eNB sending an S1 UE context release request message. In this embodiment, no direct X2 connection is established between the HeNB and the target eNB via the HeNB GW, wherein the target eNB is a macro eNB; as shown in FIG. 11, the flow of the source eNB sending an S1 UE context release request message includes:

S1102: after the preparation and execution process of X2 handover from the source HeNB to the target eNB is finished, the target eNB sends a path switch request message to the MME;

S1104: the MME transmits a path switch request acknowledge message to the target eNB;

S1106: the target eNB determines the type of the X2 connection between the target eNB and the source HeNB, if the source HeNB establishes X2 proxy connection with the target eNB via the HeNB GW, the HeNB GW indicates the target eNB that between the target eNB and the source HeNB is X2 proxy connection in the process of X2 setup or TNL address discovery, otherwise, there is no indication; or, IEs contained in X2 setup response messages in the cases of proxy connection establishment or direct connection establishment are different, then the target HeNB can determine the type of the connection between the target HeNB and the source eNB according to the IE contained in the content of the X2 setup response message; in this embodiment, if the target eNB determines that between the target eNB and the source HeNB is direct X2 connection;

S1108: the target eNB sends a UE context release message to the source HeNB, so as to indicate the source HeNB to release the context of the UE handover; since the target eNB determines that between the target eNB and the source HeNB is direct X2 connection, the message does not contain the gateway release determination information; and since between the source HeNB and the target eNB is direct X2 connection, the message is not routed and forwarded via the HeNB GW;

S1100: after the source HeNB receives the UE context release message, the message does not contain the gateway release determination information, and then it is determined that it is required to send an S1 release signaling (UE context release request message) to indicate the HeNB GW to release the context of the UE handover;

S1112: the source HeNB sends an S1AP UE context release request message to indicate the HeNB GW to release the context of the UE handover;

S1114: the HeNB GW releases the relevant resource of the UE handover, for example, A1AP ID, this step has no chronological order relationship with step S1116, that is, it may happen before step S1116 or after step S1116;

S1116: the source HeNB releases the context of the UE handover.

Preferably, the above-mentioned gateway release determination information at least includes but is not limited to one indication of the following: proxy connection indication, and indication prohibiting the signaling being used to indicate the home eNB gateway to release the context of the user equipment from being sent to the home eNB gateway, so as to realize indicating the source eNB not to send to the home eNB gateway a signaling indicating the home eNB gateway to release the context of the user equipment in different manners, and facilitating saving the resource required to send the signaling indicating the home eNB gateway to release the context of the user equipment.

Preferably, the home eNB gateway receives the X2 UE context release message; and when the signaling indicating the home eNB gateway to release the context of the user equipment sent by the source eNB is not received, the home eNB gateway releases the context of the user equipment according to the received X2 UE context release message, realizing the fact that the home eNB gateway can release the context of the user equipment and release system resources immediately and effectively.

Preferably, whether there is an X2 proxy connection between the target eNB and the source HeNB or not can be determined in at least one of the following manners: if the source HeNB establishes X2 proxy connection with the target eNB via the HeNB GW, the HeNB GW indicates the target eNB that there is an X2 proxy connection between the target eNB and the source HeNB in the process of X2 setup or TNL address discovery; or, IEs contained in X2 setup response messages in the cases of proxy connection establishment or direct connection establishment are different, then the target HeNB can determine the type of the connection between the target HeNB and the source eNB according to the IE contained in the content of the X2 setup response message.

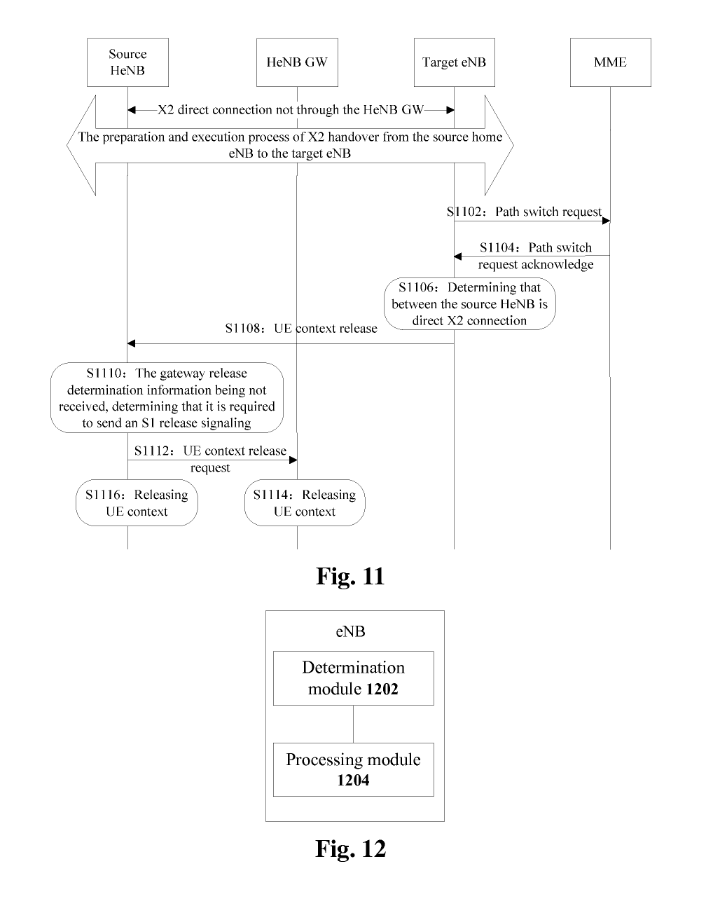

FIG. 12 shows a block diagram of the structure an eNB according to an embodiment of the disclosure; as shown in FIG. 12, the eNB includes a determination module 1202, configured to determine whether gateway release determination information sent from a home eNB gateway has been received after user equipment finishes handover; a processing module 1204, in communication with the determination module 1202, configured to prohibit the source eNB from sending to the home eNB gateway a signaling being used to indicate the home eNB gateway to release the context of the user equipment, in a case where the source eNB receives the gateway release determination information.

In the above-mentioned preferred embodiment, after the handover of the user equipment is finished, the determination module 1202 determines whether the gateway release determination information is received; when it is determined that the gateway release determination information sent by the above-mentioned home eNB gateway is received, the processing module 1204 does not send the signaling indicating the home eNB gateway to release the context of the user equipment to the home eNB gateway, reducing the redundant transmission of the signaling indicating the home eNB gateway to release the context of the user equipment, and thus improving the utility efficiency of signaling indicating the home eNB gateway to release the context of the user equipment, effectively saving the cost necessary for sending the signaling indicating the home eNB gateway to release the context of the user equipment.

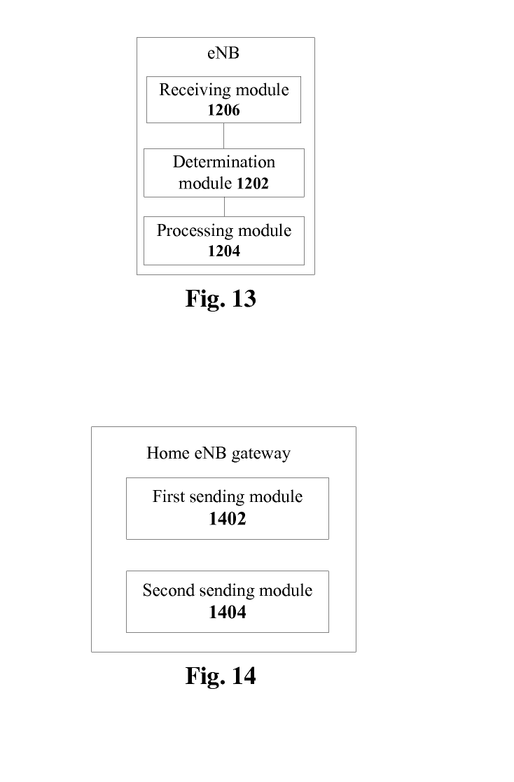

Preferably, as shown in FIG. 13, the above-mentioned eNB may further include: a receiving module 1206, configured to receive the gateway release determination information sent by the home eNB gateway, wherein the manner for receiving the gateway release determination information sent by the home eNB gateway includes: receiving a UE context release message or a handover request acknowledge message which carries the gateway release determination information and is sent by the home eNB gateway to the source eNB.

In the above-mentioned preferred embodiment, the source eNB can receive the gateway release determination information by receiving the UE context release message or the handover request acknowledge message sent by the home eNB gateway to the source eNB, the method for acquiring the gateway release determination information can be selected according to usage scenarios, thus enhancing the implementation of the disclosure.

Preferably, the above-mentioned gateway release determination information at least includes but is not limited to one indication of the following: proxy connection indication, and indication prohibiting the signaling being used to indicate the home eNB gateway to release the context of the user equipment from being sent to the home eNB gateway, so as to realize sending the signaling indicating the home eNB gateway to release the context of the user equipment to the home eNB gateway in different manners, and facilitating saving the resources required for sending the signaling indicating the home eNB gateway to release the context of the user equipment.

FIG. 14 shows a block diagram of the structural a home eNB gateway according to an embodiment of the disclosure; as shown in FIG. 14, the home eNB gateway includes: a first sending module 1402, configured to send to a source eNB a UE context release message carrying gateway release determination information; and a second sending module 1404, configured to send to the source eNB a handover request acknowledge message carrying the gateway release determination information.

In the above-mentioned preferred embodiment, the source eNB receives the gateway release determination information by receiving the UE context release message or the handover request acknowledge message, wherein when the X2 handover of the user equipment is finished, the above-mentioned handover request acknowledge message is an X2 handover request acknowledgement message.

Preferably, the above-mentioned home eNB gateway receives the X2 UE context release message; and when the signaling indicating the home eNB gateway to release the context of the user equipment sent by the source eNB is not received, the home eNB gateway releases the context of the user equipment according to the received X2 UE context release message, realizing the fact that the home eNB gateway can release the context of the user equipment and release system resources immediately and effectively.

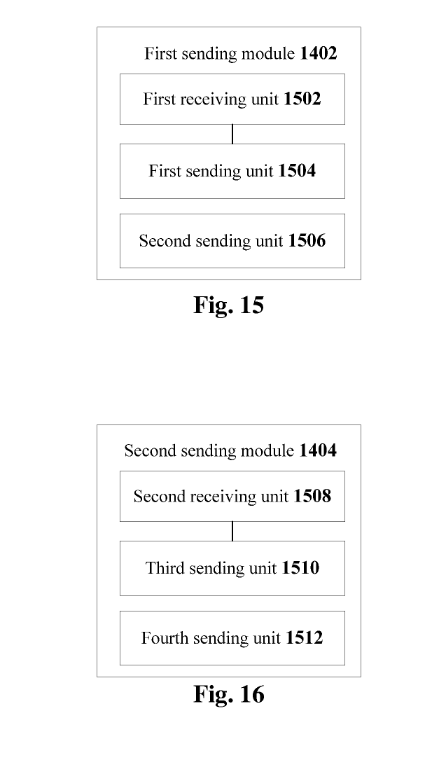

In order to satisfy the requirements of different usage scenarios, as shown in FIG. 15, the above-mentioned first sending module 1402 may include: a first receiving unit 1502, configured to receive the UE context release message sent by the target eNB; a first sending unit 1504, in communication with the first receiving unit 1502, configured to add the gateway release determination information to the UE context release message when the source eNB establishes a proxy X2 interface with the target eNB via the home eNB gateway, and to send the source eNB the UE context release message which is added with the gateway release determination information; or a second sending unit 1506, configured to forward to the source eNB the UE context release message, carrying the gateway release determination information, sent by the target eNB, when the source eNB establishes a proxy X2 interface with the target eNB via the home eNB gateway.

In the above-mentioned preferred embodiment, when a source eNB establishes a proxy X2 interface with a target eNB via a home eNB gateway, gateway release determination information will be added to the UE context release message via the home eNB gateway or the target eNB, so as to satisfy usage requirements in different scenarios, and to indicate the source eNB whether it is required to send a signaling indicating the home eNB gateway to release the context of user equipment, thereby enhancing the practicability of this embodiment.

In order to satisfy the requirements of different usage scenarios, as shown in FIG. 16, the second sending module 1404 may include: a second receiving unit 1508, configured to receive the handover request acknowledge message sent by the target eNB; a third sending unit 1510, in communication with the second receiving unit 1508, configured to add the gateway release determination information to the handover request acknowledge message, when the source eNB establishes a proxy X2 interface with the target eNB via the home eNB gateway, and to send the source eNB the handover request acknowledge message which is added with the gateway release determination information; or a fourth sending unit 1512, configured to forward to the source eNB the handover request acknowledge message, carrying the gateway release determination information, sent by the target eNB, when the source eNB establishes a proxy X2 interface with the target eNB via the gateway.

In the above-mentioned preferred embodiment, when a source eNB establishes a proxy X2 interface with a target eNB via a home eNB gateway, gateway release determination information will be added to the handover request acknowledge message via the home eNB gateway or the target eNB, so as to satisfy usage requirements in different scenarios, and to indicate the source eNB whether it is required to send a signaling indicating the home eNB gateway to release the context of user equipment, thereby enhancing the practicability of this embodiment.

In order to indicate the source eNB not to send the signaling indicating the home eNB gateway to release the context of the user equipment, the gateway release determination information can at least includes one indication of the following: proxy connection indication, and indication prohibiting the signaling being used to indicate the home eNB gateway to release the context of the user equipment from being sent to the home eNB gateway, so as to realize sending the signaling indicating the home eNB gateway to release the context of the user equipment to the home eNB gateway in different manners, and facilitating saving the resources required for sending the signaling indicating the home eNB gateway to release the context of the user equipment.

In summary, on the basis of each of the above-mentioned preferred embodiments, the disclosure provides a UE context release method and system; by means that after the handover of the user equipment is finished, the source eNB determines whether the gateway release determination information is received; the source does not send the signaling indicating the home eNB gateway to release the context of the user equipment, when it is determined that the gateway release determination information sent by the above-mentioned home eNB gateway is received; the problem in the related art that the source eNB sends a redundant signaling indicating the home eNB gateway to release the context of the user equipment, after the X2 handover procedure, thus improving the utility efficiency of signaling indicating the home eNB gateway to release the context of the user equipment, effectively saving the cost necessary for sending the signaling indicating the home eNB gateway to release the context of the user equipment.

Obviously, those skilled in the art should know that each of the mentioned modules or steps of the disclosure can be realized by universal computing devices; the modules or steps can be focused on single computing device, or distributed on the network formed by multiple computing devices; selectively, they can be realized by the program codes which can be executed by the computing device; thereby, the modules or steps can be stored in the storage device and executed by the computing device; and under some circumstances, the shown or described steps can be executed in different orders, or can be independently manufactured as each integrated circuit module, or multiple modules or steps thereof can be manufactured to be single integrated circuit module, thus to be realized. In this way, the disclosure is not restricted to any particular hardware and software combination.

The descriptions above are only the preferable embodiment of the disclosure, which are not used to restrict the disclosure, for those skilled in the art, the disclosure may have various changes and variations. Any amendments, equivalent substitutions, improvements, etc. within the principle of the disclosure are all included in the scope of the protection as defined by the appended claims of the disclosure.

1. A user equipment (UE) context release method, comprising:
a source evolved Node B (eNB) determining whether gateway release determination information sent from a home eNB gateway has been received after user equipment finishes handover;
if the source eNB has received the gateway release determination information, prohibiting a signaling, which is used to indicate the home eNB gateway to release context of the user equipment, from being sent to the home eNB gateway.

2. The method according to claim 1, wherein before the source eNB determines whether the gateway release determination information sent from the home eNB gateway has been received, the source eNB receives the gateway release determination information, wherein a manner of the source eNB receiving the gateway release determination information comprises: receiving a UE context release message or a handover request acknowledge message sent from the home eNB gateway to the source eNB, wherein the UE context release message or the handover request acknowledge message carries the gateway release determination information.

3. The method according to claim 2, wherein
if the source eNB establishes a proxy X2 interface with a target eNB via the home eNB gateway, the home eNB gateway sending the UE context release message or the handover request acknowledgment message, carrying the gateway release determination information, to the source eNB comprises: the home eNB gateway receiving the UE context release message or the handover request acknowledgment message sent by the target eNB; the home eNB gateway adding the gateway release determination information to the UE context release message or the handover request acknowledgment message, and sending to the source eNB the UE context release message or the handover request acknowledge message, which is added with the gateway release determination information; or
if the source eNB establishes a proxy X2 interface with the target eNB via the gateway, the home eNB gateway sending the UE context release message or the handover request acknowledge message, carrying the gateway release determination information, to the source eNB comprises: the home eNB gateway forwarding to the source eNB the UE context release message or the handover request acknowledge message which carries the gateway release determination information and is sent by the target eNB.

4. The method according to claim 1, wherein the gateway release determination information at least comprises one indication of the following: proxy connection indication, and indication prohibiting the signaling being used to indicate the home eNB gateway to release the context of the user equipment from being sent to the home eNB gateway.

5. An evolved Node B (eNB), comprising:
a determination module, configured to determine whether gateway release determination information sent from a home eNB gateway has been received after user equipment finishes handover;
a processing module, configured to prohibit, in a case where the determination module determines that the gateway release determination information sent from the home eNB gateway has been received, a source eNB from sending to the home eNB gateway a signaling being used to indicate the home eNB gateway to release context of the user equipment.

6. The eNB according to claim 5, further comprising:
a receiving module, configured to receive the gateway release determination information sent by the home eNB gateway, wherein a manner for receiving the gateway release determination information sent by the home eNB gateway comprises: receiving a UE context release message or a handover request acknowledge message sent by the home eNB gateway to the source eNB, wherein the UE context release message or the handover request acknowledge message carries the gateway release determination information.

7. The eNB according to claim 5, wherein the gateway release determination information at least comprises one indication of the following: proxy connection indication, and indication prohibiting the signaling being used to indicate the home eNB gateway to release the context of the user equipment from being sent to the home eNB gateway.

8. A home evolved Node B (eNB) gateway, comprising:
a first sending module, configured to send to a source eNB a UE context release message carrying gateway release determination information;
a second sending module, configured to send to the source eNB a handover request acknowledge message carrying the gateway release determination information.

9. The home evolved Node B (eNB) gateway according to claim 8, wherein the first sending module comprises:
a first receiving unit, configured to receive the UE context release message sent by a target eNB;
a first sending unit, configured to add the gateway release determination information to the UE context release message when the source eNB establishes a proxy X2 interface with the target eNB via the home eNB gateway, and send to the source eNB the UE context release message which is added with the gateway release determination information; or
a second sending unit, configured to forward to the source eNB the UE context release message which carries the gateway release determination information and is sent by the target eNB, when the source eNB establishes a proxy X2 interface with the target eNB via the gateway.

10. The home eNB gateway according to claim 8, wherein the second sending module comprises:
a second receiving unit, configured to receive the handover request acknowledge message sent by a target eNB;
a third sending unit, configured to add the gateway release determination information to the handover request acknowledge message, when the source eNB establishes a proxy X2 interface with the target eNB via the home eNB gateway, and send to the source eNB the handover request acknowledge message which is added with the gateway release determination information; or
a fourth sending unit, configured to forward to the source eNB the handover request acknowledge message which carries the gateway release determination information and is sent by the target eNB, when the source eNB establishes a proxy X2 interface with the target eNB via the gateway.

11. The home eNB gateway according to claim 8, wherein the gateway release determination information at least comprises one indication of the following: proxy connection indication, and indication prohibiting the signaling being used to indicate the home eNB gateway to release the context of the user equipment from being sent to the home eNB gateway.

12. The method according to claim 2, wherein the gateway release determination information at least comprises one indication of the following: proxy connection indication, and indication prohibiting the signaling being used to indicate the home eNB gateway to release the context of the user equipment from being sent to the home eNB gateway.

13. The method according to claim 3, wherein the gateway release determination information at least comprises one indication of the following: proxy connection indication, and indication prohibiting the signaling being used to indicate the home eNB gateway to release the context of the user equipment from being sent to the home eNB gateway.

14. The eNB according to claim 6, wherein the gateway release determination information at least comprises one indication of the following: proxy connection indication, and indication prohibiting the signaling being used to indicate the home eNB gateway to release the context of the user equipment from being sent to the home eNB gateway.

15. The home eNB gateway according to claim 9, wherein the gateway release determination information at least comprises one indication of the following: proxy connection indication, and indication prohibiting the signaling being used to indicate the home eNB gateway to release the context of the user equipment from being sent to the home eNB gateway.

16. The home eNB gateway according to claim 10, wherein the gateway release determination information at least comprises one indication of the following: proxy connection indication, and indication prohibiting the signaling being used to indicate the home eNB gateway to release the context of the user equipment from being sent to the home eNB gateway.
